(19) United States
(12) Patent Application Publication
(10) Pub. No.: US 2023/0333445 A1
(43) Pub. Date: Oct. 19, 2023

(54) ZOOM LENS ACTUATOR CONTROL DEVICE AND ZOOM CAMERA USING SAME

(71) Applicant: DONG WOON ANATECH CO., LTD, Seoul (KR)

(72) Inventors: Sungwon CHOI, Seoul (KR); Inwoo HAN, Seoul (KR); Nohyeol PARK, Seoul (KR)

(73) Assignee: DONG WOON ANATECH CO., LTD, Seoul (KR)

(21) Appl. No.: 18/336,356

(22) Filed: Jun. 16, 2023

Related U.S. Application Data
(63) Continuation of application No. PCT/KR2021/016598, filed on Nov. 15, 2021.

(30) Foreign Application Priority Data
Dec. 17, 2020 (KR) 10-2020-0177686

(51) Int. Cl. G03B 5/00

(52) U.S. Cl. CPC G03B 5/00; G03B 2205/0046; G03B 2205/0069

(57) ABSTRACT

A zoom lens actuator control device according to an embodiment of the present invention includes: a command sensing unit sensing a location command for allowing a lens unit which stops at one location on the guide rail to move to a target location on the guide rail; and a control switching unit delivering the initial control signal of the first control unit to the zoom lens actuator before a predetermined control switching time arrives after the location command is sensed by the command sensing unit, and delivering the subsequent control signal of the second control unit to the zoom lens actuator instead of the initial control signal of the first control unit when the control switching time arrives.

### CROSS-REFERENCE TO RELATED APPLICATIONS

The present application is a continuation of International Patent Application No. PCT/KR2021/016598, filed on Nov. 15, 2021, which is based upon and claims the benefit of priority to Korean Patent Application No. 10-2020-0177686, filed on Dec. 17, 2020. The disclosures of the above-listed applications are hereby incorporated by reference herein in their entirety.

### TECHNICAL FIELD

The present invention relates to a zoom lens actuator control device and a zoom camera using the same, and more particularly, to a zoom lens actuator control device that controls a zoom lens actuator moving a lens unit of a zoom lens along a guide rail disposed in the zoom lens to change a zoom magnification of the zoom lens, and a zoom camera using the same.

### BACKGROUND ART

In general, a zoom camera refers to a camera configured to enlarge or reduce an image of an object to be photographed using a zoom lens that can change a focus distance. The zoom lens applied to the zoom camera includes a zoom lens actuator that moves lens units of the zoom lens along a guide rail disposed inside the zoom lens to a front or a rear of the zoom lens to control an interval between the lens units.

However, existing proportional integral derivation (PID) control technology that controls the zoom lens actuator by combining a proportional control, a proportional-integral control, and a proportional-derivative control has a problem in that the lens unit cannot be immediately moved due to stop frictional force of the lens unit which stops on the guide rail even though driving force is generated by controlling the zoom lens actuator by a manipulation of a user, and a response delay occurs until the driving force of the zoom lens actuator is sufficiently increased through the proportional-integral control.

Moreover, the existing PID control technology adds excessive driving force to the lens unit to overcome the stop frictional force of the lens unit, so at the moment when the stop frictional force of the lens unit is converted into motor frictional force by the movement of the lens unit, the rapid movement of the lens unit is caused, and as a result, there is a problem in that excessive overshoot occurs.

Further, as disclosed in “A SIMPLE METHOD FOR COMPENSATING STICTION NONLINEARITY IN OSCILLATING CONTROL LOOPS” (JFET Vol. 6, No. 4, August-September 2014. p. 1846-1855) written by Srinivasan Arumugam, an existing technology for solving a response delay problem due to stop frictional force of a driving target by preventing a driving target from being kept in a stop state by adding a knocking signal to a control signal for controlling a driving device has a problem in that excessive vibration is generated due to the knocking signal added to the control signal when being applied to the control of the zoom lens actuator.

### DISCLOSURE

### Technical Problem

The present invention has been made in an effort to provide a zoom lens actuator control device that minimizes overshoot due to excessive driving force while preventing a response delay due to stop frictional force of a lens unit, and reduces vibration generation when a zoom lens actuator operates and a zoom camera using the same.

### Technical Solution

According to an embodiment of the present invention, a zoom lens actuator control device controlling a zoom lens actuator moving lens units of a zoom lens along a guide rail disposed inside the zoom lens to change a zoom magnification of the zoom lens includes: a command sensing unit sensing a location command for allowing a lens unit which stops at one location on the guide rail to move to a target location on the guide rail; a first control unit generating an initial control signal which allows the zoom lens actuator to generate predetermined initial driving force required for starting the lens unit to the target location; a second control unit generating a subsequent control signal for performing a proportional integral derivative (PID) control with respect to the zoom lens actuator until the movement target lens unit is placed at the target location; and a control switching unit delivering the initial control signal of the first control unit to the zoom lens actuator before a predetermined control switching time arrives after the location command is sensed by the command sensing unit, and delivering the subsequent control signal of the second control unit to the zoom lens actuator instead of the initial control signal of the first control unit when the control switching time arrives.

In an embodiment, the first control unit includes an initial driving force calculation module calculating the initial driving force of the zoom lens actuator by considering a movement direction of the lens unit according to the location command, a maximum stop frictional force of the lens unit, and an external force applied to the lens unit by a slope and a gravity of the guide rail, and a control signal generation module generating an initial control signal corresponding to the calculated initial driving force.

In an embodiment, the first control unit further includes a frictional force information provision module providing, to the initial driving force calculation module, the maximum stop frictional force information corresponding to the current location of the lens unit and a movement direction of the lens unit according to the location command by referring to a frictional force information table in which the maximum stop frictional force value of the lens unit is written for each of the movement direction and the location on the guide rail.

In an embodiment, the first control unit further includes an external force information provision module acquiring external force information on the external force which is applied to the lens unit through the sensor that senses the posture or slope of the guide rail, and providing the acquired external force information to the initial driving force calculation module.

In an embodiment, the second control unit generates a subsequent control signal for allowing the zoom lens actuator to generate a subsequent driving force of which a difference from the initial driving force is within a predetermined value when the control switching time arrives by referring to the initial control signal of the first control unit delivered to the zoom lens actuator before the control switching time arrives.

In an embodiment, the zoom lens actuator control device further includes a switching time notification unit measuring an elapsed time after the location command is sensed when the location command is sensed by the command sensing unit, and notify that the control switching time arrives to the control switching unit when the measured time reaches a predetermined reference time.

A zoom camera according to an embodiment of the present invention is configured to change a zoom magnification of a zoom lens by using the zoom lens actuator control device according to the embodiment.

The exemplary embodiments of the present invention may be implemented by using a computer program recorded in a recording medium as a computer program that executes the operations through a computer processor.

### Advantageous Effects

According to the present invention, when a location command is sensed, which is directed to move a lens unit which stops at one location on a guide rail to a target location on the guide rail, a first control unit performs an initial control which allows a zoom lens actuator to generate predetermined initial driving force which may start the lens unit to a target point without a delay, and a second control unit performs a PID control for the zoom lens actuator until the lens unit is placed at a target location according to the location command while the lens unit starts to move to minimize overshoot due to excessive driving force while preventing a response delay due to stop frictional force of the lens unit.

Further, the first control unit controls the zoom lens actuator without an additional signal which causes vibration, such as a knocking signal to reduce the vibration generation when the zoom lens actuator operates.

Further, the first control unit calculates the initial driving force of the zoom lens actuator by using a comparatively simple computation equation considering maximum stop frictional force of the lens unit and external force applied to the lens unit without using a complicated computation model to simplify a zoom magnification adjustment system of a zoom camera and reduce manufacturing cost.

Furthermore, it will be able to be apparently appreciated from the following description by those skilled in the art that various embodiments of the present invention can solve various technical problems not mentioned above.

### DESCRIPTION OF DRAWINGS

FIG. 1 is a block diagram illustrating a zoom magnification adjustment system of a zoom camera according to an embodiment of the present invention.

FIG. 2 is a diagram illustrating one example of a zoom lens applied to the zoom camera.

FIG. 3 is a diagram illustrating a zoom lens actuator control device according to an embodiment of the present invention.

FIG. 4 is a diagram illustrating forces applied to a lens unit located in a guide rail.

FIG. 5 is a diagram illustrating a first control unit of the zoom lens actuator control device according to an embodiment of the present invention.

FIG. 6 is a graph illustrating a start current of the lens unit according to a location of the lens unit.

FIG. 7 is a graph of comparing an existing PID control scheme and a zoom lens actuator control result according to the present invention.

### BEST MODE

According to an embodiment of the present invention, a zoom lens actuator control device controlling a zoom lens actuator moving lens units of a zoom lens along a guide rail disposed inside the zoom lens to change a zoom magnification of the zoom lens includes: a command sensing unit sensing a location command for allowing a lens unit which stops at one location on the guide rail to move to a target location on the guide rail; a first control unit generating an initial control signal which allows the zoom lens actuator to generate predetermined initial driving force required for starting the lens unit to the target location; a second control unit generating a subsequent control signal for performing a proportional integral derivative (PID) control with respect to the zoom lens actuator until the lens unit is placed at the target location; and a control switching unit delivering the initial control signal of the first control unit to the zoom lens actuator before a predetermined control switching time arrives after the location command is sensed by the command sensing unit, and delivering the subsequent control signal of the second control unit to the zoom lens actuator instead of the initial control signal of the first control unit when the control switching time arrives.

### Mode for Invention

Hereinafter, embodiments of the present invention will be described in detail with reference to the accompanying drawings to clarify a solution to a technical problem of the present invention. However, in the description of the present invention, if the description of related known technology will make the point of the present invention obscure, a description thereof will be omitted. In addition, terms used in this specification as terms which are defined in consideration of functions in the present invention may vary depending on an intention or a custom of a designer or a manufacturer. Accordingly, terms to be described below need to be defined based on contents throughout this specification.

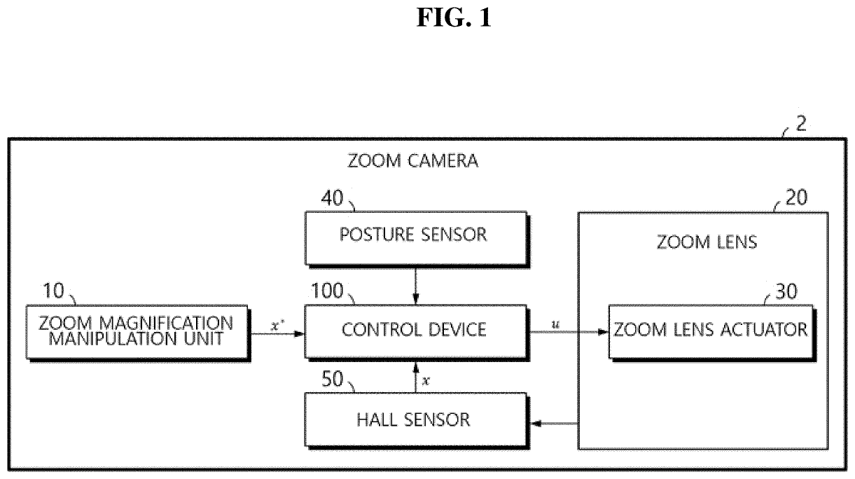

FIG. 1 illustrates a zoom magnification adjustment system of a zoom camera according to an embodiment of the present invention as a block diagram.

As illustrated in FIG. 1, the zoom magnification adjustment system of the zoom camera 2 according to an embodiment of the present invention includes a zoom magnification manipulation unit 10, the zoom lens 20, a zoom lens actuator 30, a posture sensor 40, and a hall sensor 50, and further includes a zoom lens actuator control device 100 according to the present invention.

The zoom magnification manipulation unit 10 is configured to generate a location command of changing locations of lens units disposed inside the zoom lens 20 according to a manipulation of a user to change a zoom magnification. To this end, the zoom magnification manipulation unit 10 may include an input device such as a dial or a button for adjusting the zoom magnification, or a touch screen.

The zoom lens 20 is configured to change a focus distance while maintaining a focus or an iris value of a photographed screen. Although described below again, the zoom lens 20 may include lens units and a guide rail which guide movement of the lens units. Respective lens units may include at least one convex lens, at least one concave lens, a lens module constituted by a combination of both lenses, and a lens holder that movably couples the lens module to the guide rail.

The zoom lens actuator 30 is configured to move the lens units of the zoom lens 20 along the guide rail disposed inside the zoom lens 20. To this end, the zoom lens actuator 30 may include a driving device that generates driving force. For example, the zoom lens actuator 30 may include a voice coil motor (VCM). The VCM has features such as quickness of a response, low noise, etc., to improve the operation performance and quality of the zoom lens actuator 30.

The posture sensor 40 is configured to sense a posture or slope of the guide rail disposed inside the zoom camera 2 or the zoom lens 20. To this end, the posture sensor 40 may include an acceleration sensor or a gyro sensor.

The hall sensor 50 is configured to measure current locations of the lens units which move along the guide rail disposed inside the zoom lens 20 and feed back the measured current locations to the zoom lens actuator control device 100.

The zoom lens actuator control device 100 according to the present invention is configured to change the zoom magnification of the zoom lens 20 by controlling the zoom lens actuator 30 according to the manipulation of the user in the zoom magnification adjustment system of the zoom camera 2. To this end, the zoom lens actuator control device 100 may generate a control signal u which allows the zoom lens actuator 30 to generate driving force having a predetermined direction and a predetermined magnitude by referring to a target location x* of the lens unit according to the location command generated by the zoom magnification manipulation unit 10, a current location x of the lens unit sensed by the hall sensor 50, and a posture or a slope of the zoom camera 2 or the zoom lens 20 sensed by the posture sensor 40.

The zoom lens actuator control device 100 may be implemented by combining hardware such as a memory, a processor, etc., and a computer program executed through hardware.

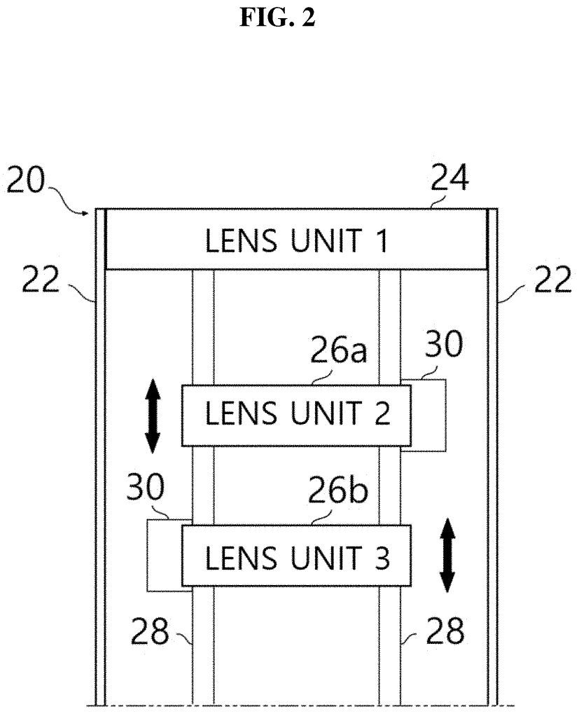

FIG. 2 illustrates one example of the zoom lens 20 applied to the zoom camera 2.

As illustrated in FIG. 2, the zoom lens 20 is configured to change the focus distance while maintaining the focus or the iris value of the photographed screen. To this end, the zoom lens 20 may include lens units 24 (26a and 26b), and a guide rail 28 which guides movement of the lens units 26a and 26b inside a frame 22 forming a support structure. Respective lens units may include at least one convex lens, at least one concave lens, a lens module constituted by a combination of both lenses, and a lens holder that movably couples the lens module to the guide rail 28.

The zoom lens actuator 30 is configured to change the focus distance of the zoom lens 20 by moving the lens units 26a and 26b to a front or a rear along the guide rail 28 disposed inside the zoom lens 20. To this end, the zoom lens actuator 30 may include a driving device such as a voice coil motor (VCM).

A frictional force should be considered which is generated between the guide rail 28 and the lens units 26a and 26b when the zoom lens actuator control device 100 controls the zoom lens actuator 30 to move the lens units 26a and 26b. In particular, since the stop frictional force of the lens unit which acts immediately before the lens units 26a and 26b which stop on the guide rail 28 starts to the target location according to the location command causes the response delay, the zoom lens actuator control device 100 should control the zoom lens actuator 30 so as to generate appropriate driving force by considering the stop frictional force of the lens unit.

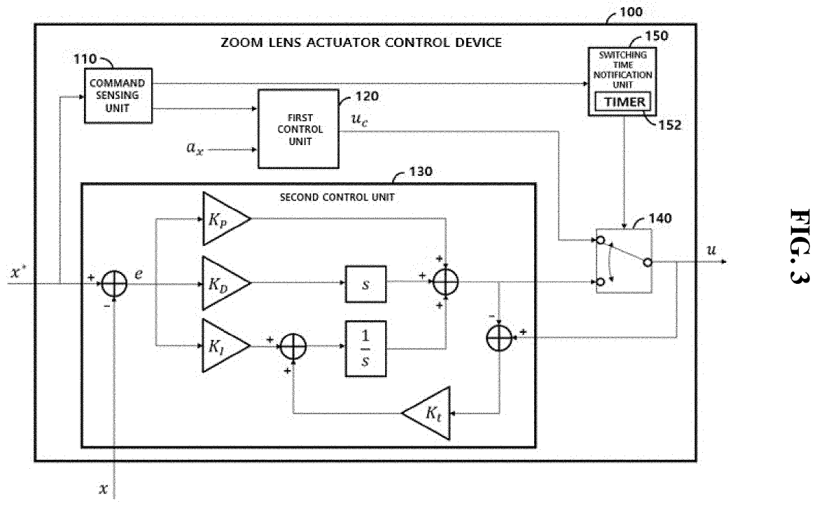

FIG. 3 illustrates the zoom lens actuator control device 100 according to an embodiment of the present invention.

As illustrated in FIG. 3, the zoom lens actuator control device 100 according to an embodiment of the present invention may include a command sensing unit 110, a first control unit 120, a second control unit 130, and a control switching unit 140, and further include a switching time notification unit 150 according to some embodiments.

The command sensing unit 110 is configured to sense the location command for allowing the lens unit which stops at one location on the guide rail 28 to move to the target location on the guide rail 28. In this case, the command sensing unit 110 may configured to sense generation of the location command and a movement direction of the lens unit according to the location command.

The first control unit 120 is configured to generate an initial control signal u_{c} for determining the initial driving force required for starting a movement target lens unit to the target location, and allowing the zoom lens actuator 30 to generate the initial driving force.

The second control unit 130 is configured to generate a subsequent control signal for performing a proportional integral derivative (PID) control with respect to the zoom lens actuator 30 until the movement target lens unit is placed at the target location.

For example, the second control unit 130 may generate a subsequent control signal for controlling the zoom lens actuator 30 by combining a proportional control of generating the control signal by multiplying an error signal e indicating an error between a reference signal x* and a current signal x by a appropriate proportional constant gain K_{P}, a derivative control of generating the control signal by multiplying and derivating the error signal e by an appropriate gain K_{D}, and an integral control of generating the control signal by multiplying and integrating the error signal e by an appropriate gain K₁.

The control switching unit 140 is configured to deliver the initial control signal of the first control unit 120 to the zoom lens actuator 30 before a predetermined control switching time arrives after the location command is sensed by the command sensing unit 110, and delivers the subsequent control signal of the second control unit 130 to the zoom lens actuator 30 instead of the initial control signal of the first control unit 120 when the control switching time arrives to switch the control unit of controlling the zoom lens actuator 30 from the first control unit 120 to the second control unit 130.

In this case, the second control unit 130 generates a subsequent control signal for allowing the zoom lens actuator 30 to generate a subsequent driving force of which a difference from the initial driving force is within a predetermined value when the control switching time arrives by referring to the initial control signal of the first control unit 120 delivered to the zoom lens actuator 30 before the control switching time arrives to prevent a phenomenon in which a sudden change occurs in the driving force of the zoom lens actuator 30 during a control switching process.

The switching time notification unit 150 is configured to measure an elapsed time after the location command is sensed by using a timer 152 when the location command is sensed by the command sensing unit 110, and notify that the control switching time arrives to the control switching unit 140 when the measured time reaches a predetermined reference time.

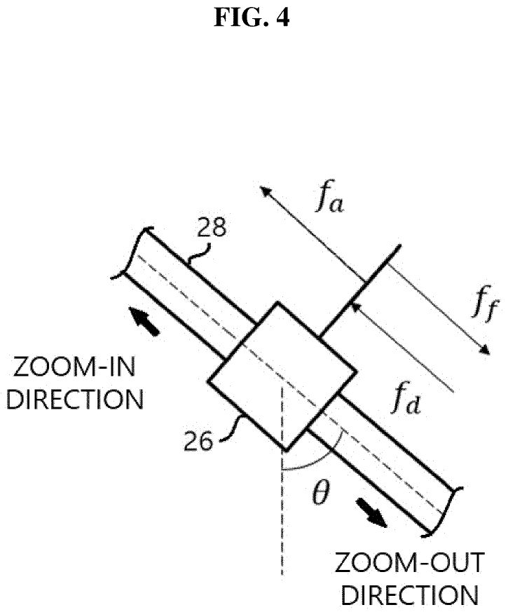

FIG. 4 illustrates forces applied to the lens unit 26 positioned in the guide rail 28.

As illustrated in FIG. 4, when the lens unit 26 is intended to be moved in a zoom-in direction in a state in which the guide rail 28 of the zoom lens 20 is inclined to form an angle of θ with a vertical direction corresponding to a gravity direction according to the posture of the zoom camera 2, a driving force fₐ of the zoom lens actuator 30 acts in the zoom-in direction, and a frictional force f_{f} acts in a zoom-out direction which is an opposite direction to the driving force fₐ. An external force f_{d} which acts on the lens unit 26 according to the slope and the gravity of the guide rail 28 may be expressed as in Equation 1.

f_{d}=−mg cos θ [Equation 1]

In Equation 1, m represents a mass of the lens unit 26, and g represents a gravity acceleration.

When a resultant force between the driving force fₐ and the external force f_{d} of the zoom lens actuator 30 is defined as f(=fₐ+f_{d}), the frictional force f_{f} which acts on the lens unit 26 may be expressed as in Equation 2.

$${f}_{f} = \{ \begin{matrix}f & ( \dot{x} = 0 and \vert f \vert \leq {F}_{S} ) \\ {F}_{S} sgn ( f ) & ( \dot{x} = 0 and \vert f \vert > {F}_{S} ) \\ {F}_{D} sgn ( \dot{x} ) & ( \dot{x} \neq 0 )\end{matrix} \qquad [ Equation 2 ]$$

In Equation 2, \dot{x} represents a speed of the lens unit 26, Fₛ represents the maximum stop frictional force of the lens unit 26, F_{D} represents a motor frictional force of the lens unit 26, and sgn represents a symbol function.

Therefore, a thrust f′ actually generated in the lens unit 26 may be expressed as in Equation 3.

$${f}^{′} = \{ \begin{matrix}0 & ( \dot{x} = 0 and \vert f \vert \leq {F}_{S} ) \\ f - {F}_{S} sgn ( f ) & ( \dot{x} = 0 and \vert f \vert > {F}_{S} ) \\ f - {F}_{D} sgn ( \dot{x} ) & ( \dot{x} \neq 0 )\end{matrix} \qquad [ Equation 3 ]$$

In Equation 3, \dot{x} represents the speed of the lens unit 26, f represents the resultant force of the driving force fₐ of the zoom lens actuator 30 and the external force f_{d} applied to the lens unit 26, Fₛ represents the maximum stop frictional force of the lens unit 26, F_{D} represents the motor frictional force of the lens unit 26, and sgn represents the symbol function.

That is, when the f which is the resultant force of the driving force fₐ and the external force f_{d} applied to the lens unit 26 in the state in which the lens unit 26 stops is smaller than the maximum stop frictional force Fₛ, a thrust f′ actually generated in the lens unit 26 becomes 0.

Further, when the f which is the resultant force of the driving force fₐ and the external force f_{d} applied to the lens unit 26 in the state in which the lens unit 26 stops is larger than the maximum stop frictional force Fₛ, a thrust f′ actually generated in the lens unit 26 becomes f−Fₛ.

Meanwhile, when the f which is the resultant force of the driving force fₐ and the external force f_{d} applied to the lens unit 26 in the state in which the lens unit 26 moves is larger than the maximum stop frictional force Fₛ, a thrust f′ actually generated in the lens unit 26 becomes f−F_{D}.

It is characterized in that the frictional force is discontinuously varied according to the force of the maximum stop frictional force or more/or less is applied according to the stop/movement state, so it is difficult to apply accurate compensation force.

In order to compensate for the frictional force of a movement target object, a scheme of measuring a speed of a target object through a predetermined sensor and judging whether the target object is currently in the stop state or the movement state, and adding the maximum stop frictional force or motor frictional force of the target object according to the driving force calculated by a controller according to a judgment result may be applied. However, when such a scheme is applied to the zoom camera, a separate sensor is required, which may accurately and rapidly measure the speed of the lens unit, so the manufacturing cost of the zoom camera is increased. Moreover, since the location of the lens unit 26 is measured by using the hall sensor 50, it is inappropriate to apply the scheme to the zoom camera 2. When the speed of the lens unit 26 is measured by a scheme of derivating the location measured by the hall sensor 50, noise is excessively generated in the process, so the magnitude of the speed and the direction may not be accurately judged, and when a low pass filter (LPF) is additionally applied to remove the noise, the complexity of the zoom camera is increased and the manufacturing cost is increased, and the response speed is decreased.

Therefore, the first control unit 120 controls the zoom lens actuator 30 to generate the initial driving force for compensating for the maximum stop frictional force of the lens unit 26 by using a comparatively simple computation equation to lower the complexity of the zoom camera, reduce the manufacturing cost, and improve the response speed.

For example, when the lens unit 26 should be moved in the zoom-in direction according to the location command, the resultant force of the initial driving force f_{c} which should be generated by the zoom lens actuator 30 according to the control of the first control unit 120 and the external force f_{d} applied to the lens unit 26 should be a value larger than the maximum stop frictional force Fₛ of the lens unit 26, so the initial driving force f_{c} may be expressed as in Equation 4.

f_{c}>Fₛ−f_{d} [Equation 4]

In Equation 4, f_{c} represents the initial driving force calculated by the first control unit 120, Fₛ represents the maximum stop frictional force of the lens unit 26, and f_{d} represents the external force applied to the lens unit 26.

Therefore, when the lens unit 26 should be moved in the zoom-in direction according to the location command, the first control unit 120 may calculate the initial driving force f_{c} by using a computation equation shown in Equation 5.

f_{c}=Fₛ−f_{d}+fₘ [Equation 5]

In Equation 4, f_{c} represents the initial driving force calculated by the first control unit 120, Fₛ represents the maximum stop frictional force of the lens unit 26, f_{d} represents the external force applied to the lens unit 26, and fₘ represents a margin value for guaranteeing so that the resultant force of the initial driving force f_{c} and the external force f_{d} has a value larger than the maximum stop frictional force Fₛ.

Meanwhile, when the lens unit 26 should be moved in the zoom-out direction according to the location command, the initial driving force f_{c} which should be generated by the zoom lens actuator 30 may be expressed as in Equation 6 according to the control of the first control unit 120.

f_{c}<−Fₛ−f_{d} [Equation 6]

In Equation 6, f_{c} represents the initial driving force calculated by the first control unit 120, Fₛ represents the maximum stop frictional force of the lens unit 26, and f_{d} represents the external force applied to the lens unit 26.

Therefore, when the lens unit 26 should be moved in the zoom-in direction according to the location command, the first control unit 120 may calculate the initial driving force f_{c} by using a computation equation shown in Equation 7.

f_{c}=−Fₛ−f_{d}−fₘ′[Equation 7]

In Equation 4, f_{c} represents the initial driving force calculated by the first control unit 120, Fₛ represents the maximum stop frictional force of the lens unit 26, f_{d} represents the external force applied to the lens unit 26, and fₘ′ represents a margin value for guaranteeing so that the resultant force of the initial driving force −f_{c} and the external force −f_{d} has a value larger than the maximum stop frictional force Fₛ.

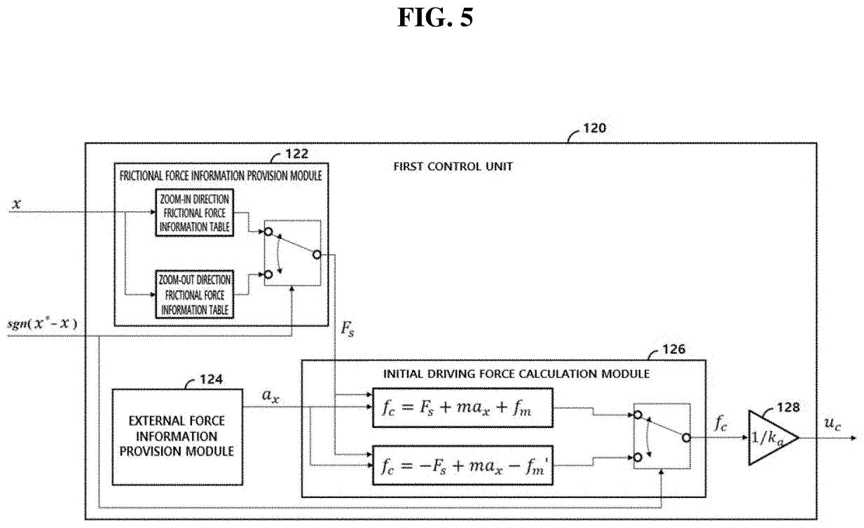

FIG. 5 illustrates the first control unit 120 of the zoom lens actuator control device according to an embodiment of the present invention.

As illustrated in FIG. 5, the first control unit 120 may include an initial driving force calculation module 126 and a control signal generation module 128, and further include a frictional force information provision module 122 and an external force information provision module 124 according to some embodiments.

The frictional force information provision module 122 may be configured to provide, to the initial driving force calculation module 126, the maximum stop frictional force information Fₛ corresponding to the current location x of the lens unit 26 and a movement direction sgn(x*−x) according to the location command x* by referring to a frictional force information table in which the maximum stop frictional force value of the lens unit 26 is written for each of the movement direction and the location on the guide rail 28. In this case, the frictional force information provision module 122 may prestore and keep a first frictional force information table applied when the lens unit moves in the zoom-in direction and a second frictional force information table applied when the lens unit moves in the zoom-out direction.

The external force information provision module 124 may be configured to acquire external force information (aₓ=−g·cos θ) on the external force which is applied to the lens unit 26 through the sensor that senses the posture or slope of the guide rail 28, and provide the acquired external force information aₓ to the initial driving force calculation module 126. In this case, the external force information provision module 124 may be configured to acquire the external force information aₓ from an acceleration sensor installed in the zoom camera 2 for optical image stabilization (OIS).

The initial driving force calculation module 126 may be configured to calculate the initial driving force f_{c} of the zoom lens actuator 30 by considering the movement direction of the lens unit 26 according to the location command, the maximum stop frictional force Fₛ of the lens unit 26, and an external force max applied to the lens unit 26 by the slope and the gravity of the guide rail 28.

The control signal generation module 128 may be configured to generate the initial control signal u_{c} corresponding to the calculated initial driving force f_{c}. In this case, the initial control signal u_{c} may be generated as a value acquired by multiplying the calculated initial driving force f_{c} by a predetermined proportional coefficient 1/kₐ.

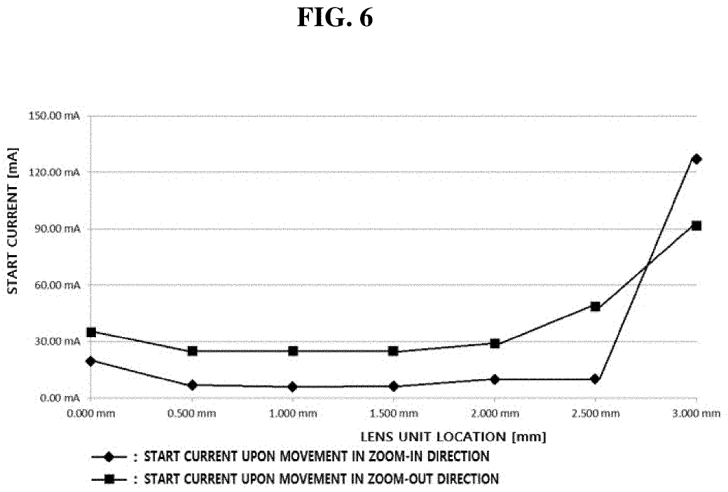

FIG. 6 is a graph illustrating a start current of the lens unit according to the location of the lens unit.

As illustrated in FIG. 6, it can be seen that as a result of measuring a start current input at a time when the lens unit is moved by gradually increasing a current amount input into the zoom lens actuator in the state in which the lens unit stops on the guide rail, the start current shows different current values according to the location and the movement direction of the lens unit. That is, it can be seen that the maximum stop frictional force applied to the lens unit varies depending on the location and the movement direction of the lens unit.

Therefore, the frictional force information provision module 122 of the first control unit 120 may prestore and keep a frictional force information table in which the maximum stop frictional force value of the lens unit 26 is written for each of the movement direction and the location on the guide rail 28, and provide to the initial driving force calculation module 126 the maximum stop frictional force information Fₛ corresponding to the current location x of the lens unit 26 and a movement direction according to the location command.

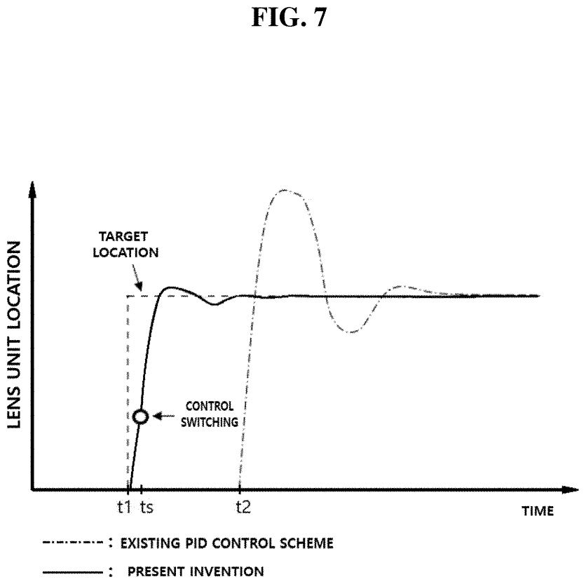

FIG. 7 illustrates a graph of comparing an existing PID control scheme and response characteristics according to the present invention.

As illustrated in FIG. 7, it can be seen that in the existing PID control scheme, even though the location command according to the user manipulation is input at a time t1, and generates the driving force of the zoom lens actuator, the lens unit is not immediately moved due to the stop frictional force of the lens unit which stops on the guide rail, and the response delay occurs up to a time t2 when the driving force of the zoom lens actuator is sufficiently increased through the proportional integral control. Moreover, it can be seen that the existing PID control scheme adds excessive driving force to the lens unit to overcome the stop frictional force of the lens unit, so at the moment when the stop frictional force of the lens unit is converted into motor frictional force by the movement of the lens unit, the rapid movement of the lens unit is caused, and as a result, excessive overshoot occurs.

On the contrary, according to the present invention, it can be seen that when the location command is sensed at the time t1, the first control unit performs an initial control which allows the zoom lens actuator to generate a predetermined initial driving force to start the lens unit to a target point without a delay and shows an immediate response, and when the lens unit starts to move, control switching is made at a time ts, so the second control unit performs the PID control for the zoom lens actuator to prevent the response delay due to the stop frictional force of the lens unit and minimize overshoot due to the excessive driving force.

Meanwhile, embodiments of the present invention may be implemented by a computer system and a computer program for driving the computer system. When the embodiments of the present invention are implemented as the computer program, the components of the present invention may include program segments that execute the operation or task through that computer system. These computer programs or program segments may be stored in various computer-readable recording media. The computer-readable recording media may include all types of media in which data readable by the computer system are recorded. For example, the computer-readable recording media may include a ROM, a RAM, an EEPROM, a register, a flash memory, a CD-ROM, a magnetic tape, a hard disk, a floppy disk, or an optical data recording device. Further, the recording media are distribute and disposed in computer system connected by various networks to store or execute the program codes in a distribution scheme.

As described above, according to the present invention, when the location command is sensed, which is directed to move the lens unit which stops at one location on the guide rail to the target location on the guide rail, the first control unit performs the initial control which allows the zoom lens actuator to generate the predetermined initial driving force which may start the lens unit to the target point without the delay, and the second control unit performs the PID control for the zoom lens actuator until the lens unit is placed at a target location according to the location command while the lens unit starts to move to minimize the overshoot due to the excessive driving force while preventing the response delay due to the stop frictional force of the lens unit.

Further, the first control unit controls the zoom lens actuator without an additional signal which causes vibration, such as a knocking signal to reduce the vibration generation when the zoom lens actuator operates.

Further, the first control unit calculates the initial driving force of the zoom lens actuator by using a comparatively simple computation equation considering maximum stop frictional force of the lens unit and external force applied to the lens unit without using a complicated computation model to simplify a zoom magnification adjustment system of a zoom camera and reduce manufacturing cost.

Furthermore, the embodiments according to the present invention can solve other technical problems other than the contents mentioned herein as well as the related technical field as well as the technical field.

So far, the present invention has been explained by referring to specific embodiments. However, it will be able to be clearly appreciated by those skilled in the art that various modified embodiments can be implemented in the technical scope of the present invention. Therefore, the disclosed embodiments should be considered in an illustrative viewpoint rather than a restrictive viewpoint. That is, the scope of the true technical idea of present disclosure is described in the claims, and all differences within the scope of equivalents thereof should be construed as being included in the present disclosure.

1. A zoom lens actuator control device controlling a zoom lens actuator moving lens units of a zoom lens along a guide rail disposed inside the zoom lens to change a zoom magnification of the zoom lens, comprising:
a command sensing unit sensing a location command for allowing a lens unit which stops at one location on the guide rail to move to a target location on the guide rail;
a first control unit generating an initial control signal which allows the zoom lens actuator to generate predetermined initial driving force required for starting the lens unit to the target location;
a second control unit generating a subsequent control signal for performing a proportional integral derivative (PID) control with respect to the zoom lens actuator until the lens unit is placed at the target location; and
a control switching unit delivering the initial control signal of the first control unit to the zoom lens actuator before a predetermined control switching time arrives after the location command is sensed by the command sensing unit, and delivering the subsequent control signal of the second control unit to the zoom lens actuator instead of the initial control signal of the first control unit when the control switching time arrives.

2. The zoom lens actuator control device of claim 1, wherein the first control unit includes
an initial driving force calculation module calculating the initial driving force of the zoom lens actuator by considering a movement direction of the lens unit according to the location command, a maximum stop frictional force of the lens unit, and an external force applied to the lens unit by a slope and a gravity of the guide rail, and
a control signal generation module generating an initial control signal corresponding to the calculated initial driving force.

3. The zoom lens actuator control device of claim 2, wherein the first control unit further includes a frictional force information provision module providing, to the initial driving force calculation module, the maximum stop frictional force information corresponding to the current location of the lens unit and a movement direction of the lens unit according to the location command by referring to a frictional force information table in which the maximum stop frictional force value of the lens unit is written for each of the movement direction and the location on the guide rail.

4. The zoom lens actuator control device of claim 2, wherein the first control unit further includes an external force information provision module acquiring external force information on the external force which is applied to the lens unit through the sensor that senses the posture or slope of the guide rail, and providing the acquired external force information to the initial driving force calculation module.

5. The zoom lens actuator control device of claim 1, wherein the second control unit generates a subsequent control signal for allowing the zoom lens actuator to generate a subsequent driving force of which a difference from the initial driving force is within a predetermined value when the control switching time arrives by referring to the initial control signal of the first control unit delivered to the zoom lens actuator before the control switching time arrives.

6. The zoom lens actuator control device of claim 1, further comprising:
a switching time notification unit measuring an elapsed time after the location command is sensed when the location command is sensed by the command sensing unit, and notify that the control switching time arrives to the control switching unit when the measured time reaches a predetermined reference time.

7. A zoom camera using the zoom lens actuator control device of claim 1.
